(19) United States
(12) Patent Application Publication
(10) Pub. No.: US 2024/0247526 A1
(43) Pub. Date: Jul. 25, 2024

(54) UMBRELLA SHARING SYSTEM AND GATE DEVICE THEREOF

(71) Applicant: FUNCROWD INC., Taipei City (TW)

(72) Inventors: Chun-Chia SU, Taipei City (TW); Chi-Yao YU, Taipei City (TW); Po-Feng WANG, Taipei City (TW); Po Ying SU, Taipei City (TW); Ting-Yuan CHENG, Taipei City (TW); Hsin-En FANG, Taipei City (TW); ShaoTing YEN, Taipei City (TW); Pin Wei LIAO, Taipei City (TW); An-Li TING, Taipei City (TW); Hsien An WU, Taipei City (TW); Po-Hsun SU, Taipei City (TW)

(21) Appl. No.: 18/416,091

(22) Filed: Jan. 18, 2024

(30) Foreign Application Priority Data
Jan. 19, 2023 (TW) 112102884

(51) Int. Cl. E05F 1/12; A45B 9/02; B65G 1/08; E05B 47/00; G06Q 10/087

(52) U.S. Cl. CPC E05F 1/1207; A45B 9/02; B65G 1/08; E05B 47/0004; G06Q 10/087

(57) ABSTRACT

The instant disclosure provides a gate device and an umbrella sharing system which utilizes the gate device. The gate device includes a base, an actuator, a pair of gate plates, and an identification sensor. The actuator is disposed on a top surface of the base and includes a latch extending downward through the base. The pair of gate plates are disposed on a bottom surface of the base, and each of the gate plates includes a guiding structure and a locking structure. A waiting zone for receiving an umbrella is defined between the two guiding structures. The latch of the actuator is driven to engage with the locking structures to limit the movement of the gate plates. The identification sensor is above the waiting zone and disposed on the base and is configured to identify the identity of an umbrella which enters the waiting zone. The umbrella sharing system includes a rail for receiving the umbrella and two gate devices disposed on an entrance end and an exit end of the rail to regulate the loading and the removal of the umbrella.

### BACKGROUND OF THE INVENTION

### 1. Field of the Invention

The instant disclosure relates to an umbrella sharing system, and in particular to a semi-automatic umbrella renting and returning system.

### 2. Description of the Related Art

With the rapid development of global network technology, mobile devices and network platforms have gradually become popular, and a variety of business models that are different from the traditional ones have gradually emerged. Sharing Economy is one of the emerging industries after the continuous innovation of many enterprises in recent years. Sharing Economy refers to the fact that resources can be shared, exchanged and rented out by participants who do not own the assets, thus maximizing the efficiency of resource utilization. With the popularization of Internet technology, geographical limitations can be easily eliminated and scattered resources in various regions can be connected, allowing consumers to quickly find the services they need anytime and anywhere. Sharing Economy application platforms also enable resource demanders and suppliers to exchange resources with each other, so that people no longer need to purchase some assets, but can obtain the right to use products at a lower cost.

Umbrella rental service, a part of the Sharing Economy, provides the service of renting and returning umbrellas by setting up umbrella rental stations in public areas, to meet the temporary needs of users for using umbrellas and avoid the inconvenience of carrying umbrellas with them. Traditionally, a hardware facility for providing umbrella rental service uses a non-replaceable password lock to secure the umbrellas. When the user needs to rent an umbrella, he or she may obtain a password for the password lock from the service provider through communication, and is then allowed to open the password lock and obtain the umbrella. When returning the umbrella, the user needs to lock the umbrella to the password lock and inform the service provider that the umbrella has been returned. The above hardware facility providing umbrella rental service has at least the following problems: (1) the password lock is not connected to the Internet, so the service provider is unable to know when the password lock is opened or closed, and thus unable to instantly determine whether the umbrella has been returned; (2) the password of the password lock is unchangeable, and user can rent the umbrella again and again by following the same password after the password has been given to him or her; and (3) this facility is unable to identify the identity of the umbrella, so that the service provider is unable to instantly determine whether the user has returned the umbrella.

Therefore, a new system is needed to solve the problems in the traditional umbrella rental hardware facilities.

### SUMMARY OF THE INVENTION

An objective of the instant disclosure is to provide an umbrella sharing system, which controls the retrieval and return of umbrellas by means of a novel gate device. In addition, a detection unit is further disposed above the gate device to dynamically monitor the identities and quantity of the umbrellas in the umbrella sharing system in real time during the process of moving the umbrellas in and out of the umbrella sharing system and monitor whether any abnormalities occur.

According to an embodiment of the instant disclosure, the gate device includes: a base, extending from a first end to a second end along an axis, and including a first area and a second area respectively adjacent to the first end and the second end; an actuator, disposed on a top surface of the second area of the base and including a latch extending downward through the base, the actuator being operable to move the latch between a locked position and a retracted position; a first gate plate and a second gate plate, disposed on a bottom surface of the first area of the base; and an identification sensor. Each of the first gate plate and the second gate plate includes: a guiding structure, a waiting zone being defined between the guiding structures of the first gate plate and the second gate plate; and a locking structure, connected with the guiding structure and extending toward the second end of the base. When the latch is in the locked position, the locking structures of the first gate plate and the second gate plate engage with the latch such that pivoting of the first gate plate and the second gate plate is limited. When the latch is in the retracted position, the latch is separated from the locking structure such that the first gate plate and the second gate plate are pivotable from a closed position to an open position. The identification sensor is disposed on the first area of the base relative to the waiting zone and configured to identify an identity of an umbrella which passes through the gate device.

In addition, according to an embodiment of the instant disclosure, the umbrella sharing system includes a housing, having an elongated opening at a lower end thereof; a rail, including an elongated slot extending along the elongated opening; two gate devices as described above, respectively disposed on an entrance end and an exit end of the elongated slot; and an umbrella. The umbrella includes: a handle, defining a groove, the handle sliding on the rail through the groove, the two gate devices being configured such that the handle enters the gate device via the first end of the base and leaves the gate device via the second end of the base after passing through the waiting zone between the first gate plate and the second gate plate; and an identification chip, disposed in a head of the handle such that when the handle slides through the waiting zone, the identification sensor identifies the identification chip to determine an identity of the umbrella.

According to another embodiment of the instant disclosure, the umbrella sharing system includes: a rail, defining an elongated slot that allows an umbrella to slide through, at least one section of the elongated slot being inclined at an included angle with respect to a horizontal direction, and the included angle being about 7 degrees to about 20 degrees; two gate devices, respectively disposed on the rail relative to an entrance end and an exit end of the elongated slot; and an umbrella, configured to be slidable on the rail, one of the two gate devices disposed relative to the entrance end being configured to control the umbrella to be moved into the elongated slot, and the other of the two gate devices disposed relative to the exit end being configured to control the umbrella to be moved out of the elongated slot.

### BRIEF DESCRIPTION OF THE DRAWINGS

FIG. 1 shows a schematic front view of an umbrella sharing system according to an embodiment of the instant disclosure;

FIG. 2 shows a schematic side view of the umbrella sharing system according to an embodiment of the instant disclosure;

FIG. 3 shows a schematic view of a main body according to an embodiment of the instant disclosure;

FIG. 4 shows a schematic view of a gate device located on an exit end according to an embodiment of the instant disclosure;

FIG. 5 shows a schematic view of a gate plate assembly according to an embodiment of the instant disclosure;

FIG. 6 shows a schematic view of a gate plate assembly between a closed position and an open position according to an embodiment of the instant disclosure;

FIG. 7 shows a schematic bottom view of a gate device according to another embodiment of the instant disclosure;

FIG. 8 shows a schematic view of the gate device located on an entrance end according to an embodiment of the instant disclosure;

FIG. 9 shows a schematic side view of a gate device according to still another embodiment of the instant disclosure;

FIG. 10 shows a schematic bottom view of the gate device of FIG. 9;

FIG. 11 shows a structural exploded view of a handle according to an embodiment of the instant disclosure;

FIG. 12 shows a schematic view of a step of an umbrella passing through the gate device according to an embodiment of the instant disclosure, where the handle of the umbrella enters the gate device via a first end of a base;

FIG. 13 shows a schematic view of a step of an umbrella passing through the gate device according to an embodiment of the instant disclosure, where the handle of the umbrella is in located a waiting zone and below an identification sensor, two gate plates of the gate plate assembly are in the closed position and a latch is in a locked position;

FIG. 14 shows a schematic view of a step of an umbrella passing through the gate device according to an embodiment of the instant disclosure, where the handle of the umbrella pushes the gate plate assembly such that the locking structure passes through a switch sensor;

FIG. 15 shows a schematic view of a step of an umbrella passing through the gate device according to an embodiment of the instant disclosure, where the two gate plates of the gate plate assembly are in the open position;

FIG. 16 shows a schematic view of a step of an umbrella passing through the gate device according to an embodiment of the instant disclosure, where the two gate plates of the gate plate assembly move from the open position to the closed position;

FIG. 17 shows a schematic view of a step of an umbrella passing through the gate device according to an embodiment of the instant disclosure, where the locking structure of the gate plate assembly passes through the switch sensor;

FIG. 18 shows a schematic view of a step of an umbrella passing through the gate device according to an embodiment of the instant disclosure, where the handle of the umbrella leaves the gate device via a second end of the base, the two gate plates of the gate plate assembly are in the closed position and the latch is in the locked position;

FIG. 19 shows a schematic front view of an umbrella sharing system according to another embodiment of the instant disclosure; and

FIG. 20 shows a schematic sectional view of the umbrella sharing system according to another embodiment of the instant disclosure.

### PREFERRED EMBODIMENT OF THE PRESENT INVENTION

In order to better understand the features, contents and advantages of the instant disclosure and the effects it can achieve, the instant disclosure will be illustrated in detail with reference to the accompanying drawings and in the form of embodiments, and the drawings used therein are only for schematic and auxiliary instructions, so the scope of the instant disclosure should not be interpreted and limited by the proportion and configuration relationship of the accompanying drawings.

The term “a” or “an” is used herein to describe the elements and components of the instant disclosure. This term is only for convenience of description and to give the basic concept of the instant disclosure. This description should be understood as including one or at least one, and should include the plural when referring to the singular, unless clearly indicated otherwise. When used together with the term “comprise” in the claims, the term “a” can mean one or more than one. In addition, the term “or” herein has the same meaning as “and/or”.

Unless otherwise specified, spatial descriptions such as “above”, “below”, “up”, “left”, “right”, “down”, “body”, “base”, “vertical”, “horizontal”, “side”, “higher”, “lower”, “upper”, “on”, “under” and so forth, are indicative with respect to the direction shown in the drawings. It should be understood that the spatial descriptions used herein are for illustrative purposes only, and the actual implementation of the structures described herein may be configured spatially in any relative orientation. This limitation shall not change the advantages of the embodiments of the instant disclosure. For example, in the description of some embodiments, providing an element “on” another element may cover the situation that the former element is directly on the latter element (for example, in physical contact with the latter element) and the situation that one or a plurality of intervening elements are located between the former element and the latter element.

As used herein, the terms “generally”, “substantially”, “essentially” and “approximately” are used to describe and consider minor changes. When used in conjunction with an event or condition, the plural term can mean a situation in which the event or condition clearly occurs and a situation in which the event or condition almost occurs.

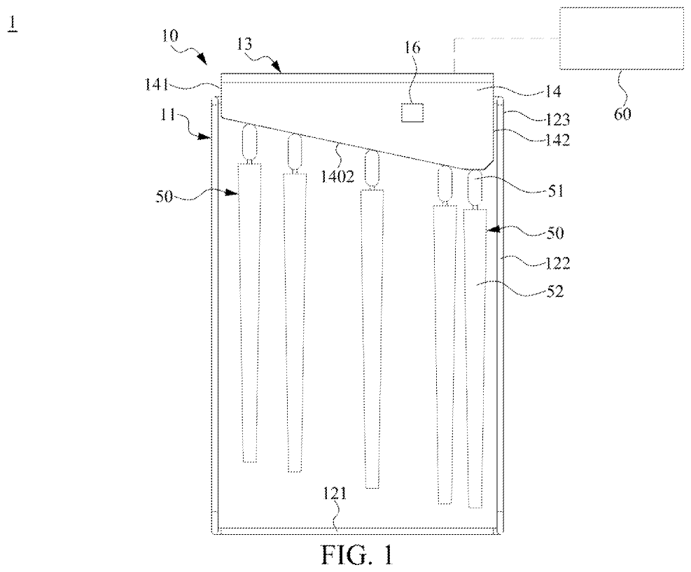

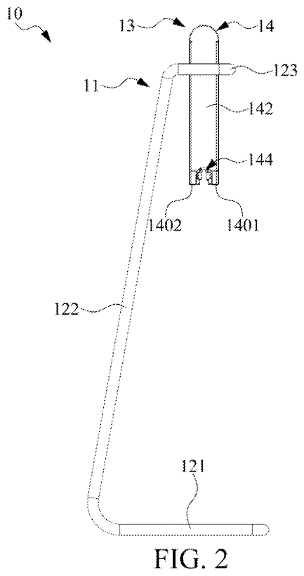

FIG. 1 shows a schematic front view of an umbrella sharing system according to an embodiment of the instant disclosure, and FIG. 2 shows a schematic side view of the umbrella sharing system according to an embodiment of the instant disclosure. The umbrella sharing system 1 according to an embodiment of the instant disclosure includes an umbrella rental station 10 and a remote servo system 60. The umbrella rental station 10 may be disposed in a public place for registered users to rent umbrellas. Preferably, the umbrella rental station 10 is disposed in a sheltered space, such as a metro station, a bus shelter and an arcade, in order to meet the basic quality requirements of waterproofing, resistance to degradation by sunlight exposure, stability, etc. The umbrella rental station 10 may be coupled to the remote servo system 60 via a wireless communication module through signals to transmit or receive information about umbrella rental by users. For example, the wireless communication module may include a wireless communication device using a SIM card.

In an embodiment, the umbrella rental station 10 includes a frame 11 and a main body 13. The frame 11 has a height, such that when the main body 13 is disposed on the frame 11, a lower end of the main body 13 provides a space for disposing umbrellas 50. As shown in FIG. 2, in an embodiment, the frame 11 includes a plurality of tubes. For example, the frame 11 includes a first tube 121, two second tubes 122 and a third tube 123. The two second tubes 122 are disposed on two sides of the frame 11. The third tube 123 is bent into an “n” shape, and two ends of the third tube are respectively coupled to upper ends of the two second tubes 122. The main body 13 is suspended on the third tube 123. Similarly, the first tube 121 is bent into an “n” shape, and two ends of the first tube are respectively coupled to lower ends of the two second tubes 122. The frame 11 is disposed on a ground by means of the first tube 121. The structural forms of the frame 11 may be adaptively adjusted according to the position where the umbrella rental station 10 is disposed, and is not limited to this embodiment. In another embodiment, the frame 11 is omitted, and the main body 13 may be directly mounted on a wall surface.

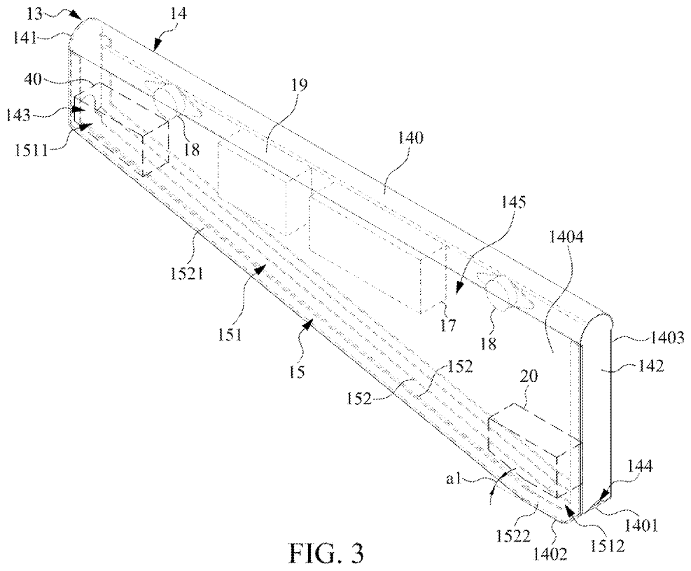

FIG. 3 shows a schematic view of the main body 13 according to an embodiment of the instant disclosure. In an embodiment, the main body 13 includes a housing 14 and a rail 15. The housing 14 includes a body 140. The body 140 includes a metal plate, which is bent to have two side covers 1403, 1404 disposed oppositely. The housing 14 further includes an entrance end cover 141 and an exit end cover 142, which are respectively located on two sides of the main body 13 along a length direction and each connected with the two side covers 1403, 1404. As shown in FIG. 3, an entrance channel 143 is provided below the entrance end cover 141. Additionally, as shown in FIG. 2, an exit channel 144 is provided below the exit end cover 142.

An elongated opening is defined between lower side edges 1401, 1402 of the two side covers 1403, 1404. The rail 15 is disposed in the elongated opening between the lower side edges 1401, 1402 of the two side covers 1403, 1404, and has an elongated slot 151 that allows the umbrellas (not shown in FIG. 3) to slide through. An entrance end 1511 of the elongated slot 151 is adjacent to the entrance channel 143, and an exit end 1512 of the elongated slot 151 is adjacent to the exit channel 144. Thus, the umbrella may enter the elongated slot 151 via the entrance channel 143 and the entrance end 1511 of the rail 15, and leave the elongated slot 151 via the exit end 1512 of the rail 15 and the exit channel 144 after passing through the elongated slot 151.

In an embodiment, as shown in FIG. 3, the rail 15 includes two strip-shaped plates 152 respectively disposed on inner sides of the side covers 1403, 1404, and the elongated slot 151 is defined between the two strip-shaped plates 152. In an embodiment, the strip-shaped plate 152 includes an inclined section 1521 and a horizontal section 1522. The inclined section 1521 extends a predetermined length from the entrance end 1511 of the elongated slot 151 and is inclined at an included angle a1 with respect to a horizontal direction. Additionally, the horizontal section 1522 is connected with one end of the inclined section 1521, and extends to the exit end 1512 of the elongated slot 151 along the horizontal direction. In an example, the included angle a1 is 7 to 20 degrees. Preferably, the included angle a1 is about 12 degrees. According to the experimental results of the inventors of the instant disclosure, setting the included angle a1 to be greater than or equal to 7 degrees facilitates the umbrella to slide smoothly by gravity from the entrance end 1511 of the rail 15 to the exit end 1512 of the rail 15 after entering the elongated slot 151, and setting the included angle a1 to be smaller than or equal to 20 degrees can reduce the height difference between the entrance end and the exit end. The rail 15 may be made of plastics, metals or other suitable materials.

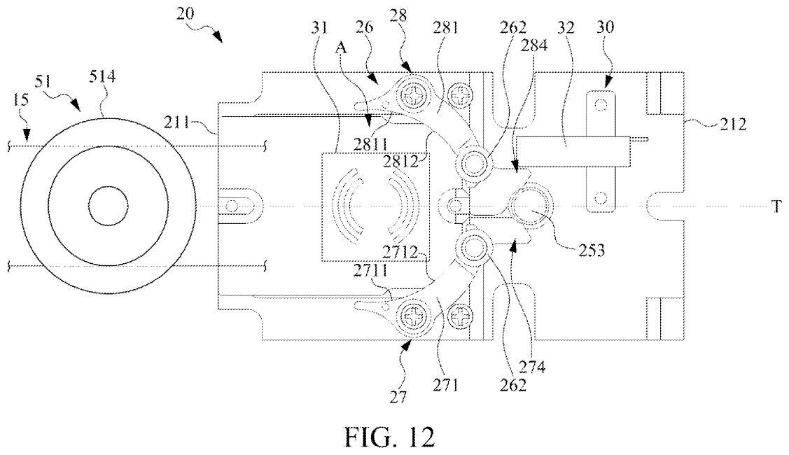

One or more electronic elements may be disposed in an accommodating space 145 between the two side covers 1403, 1404. For example, the umbrella rental station 10 may include an electrical box 17, a plurality of speakers 18, a power source 19, and two gate devices 20, 40 which are disposed in an accommodating space 145. The electrical box 17 may include a plurality of electronic elements for controlling operation of the umbrella sharing system. For example, the electrical box 17 includes a wireless communication module and a controller module. The wireless communication module is configured to transmit and receive electronic signals between the umbrella rental station 10 and the remote servo system 60. The controller module (e.g., microcontroller unit) is configured to process information from a detection unit 30 (which will be further described later in the embodiment of FIG. 12 to FIG. 18) and the wireless communication module, and generate a control signal according to the received information to control the speakers 18 or the gate devices 20, 40. The power source 19 is electrically connected to the electrical box 17, the plurality of speakers 18, and the two gate devices 20, 40 to provide power required by these elements. The power source 19 may be a rechargeable battery, a portable mobile power supply, or a power controller connected to the mains supply.

The two gate devices 20, 40 are configured to control the umbrella to be moved into the main body 13 or out of the main body 13. In an embodiment, the gate device 20 is disposed on the exit end 1512 of the rail 15, and configured to restrict the umbrella from passing through the exit end 1512 of the rail 15. The gate device 40 is disposed on the entrance end 1511 of the rail 15, and configured to restrict the umbrella from passing through the entrance end 1511 of the rail 15. According to embodiments of the instant disclosure, the structures of the gate devices 20, 40 are described below:

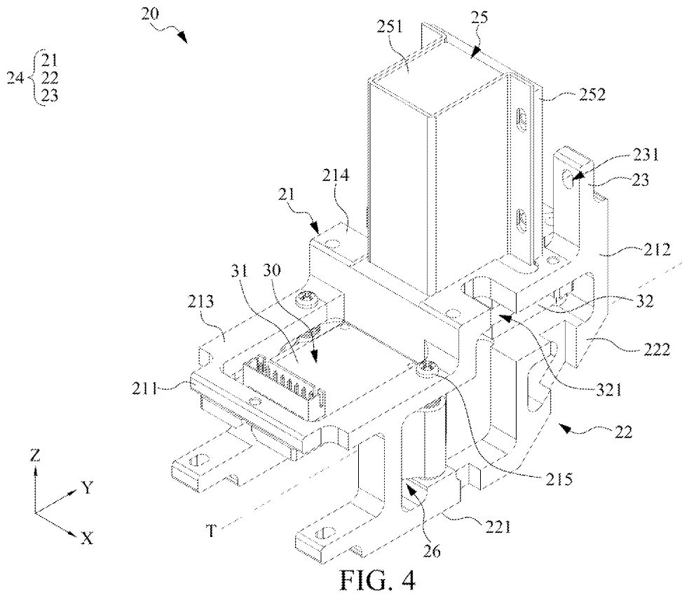

FIG. 4 shows a schematic view of the gate device 20 according to an embodiment of the instant disclosure. In an embodiment, the gate device 20 includes a base 21, a bottom bracket 22, an extension bracket 23, an actuator 25, and a gate plate assembly 26. The base 21 may include areas with different heights to facilitate the passage of the umbrellas. For example, as shown in FIG. 4, the base 21 extends along an axis T from a first end 211 to a second end 212 opposite to the first end 211. A first area 213 is adjacent to the first end 211, and a second area 214 is adjacent to the second end 212. The height of the second area 214 is greater than the height of the first area 213. The bottom bracket 22 is disposed on two opposite side edges below the base 21 to define a channel below the base 21 for the passage of the umbrella. In an embodiment, the bottom bracket 22 includes a connecting portion 221 and an inclined portion 222 inclined relative to the connecting portion 221. The connecting portion 221 and the inclined portion 222 are substantially respectively disposed below the first area 213 and the second area 214 of the base 21. The extension bracket 23 is disposed adjacent to the second end 212 above the base 21, and a locking hole 231 is formed in the extension bracket 23.

The base 21, the bottom bracket 22, and the extension bracket 23 together form a gate seat 24 for carrying the actuator 25, the gate plate assembly 26, and the detection unit 30. In an exemplary embodiment, the gate seat 24 is formed by performing CNC milling on an aluminum extrusion as a blank. However, the instant disclosure is not limited thereto. The base 21, the bottom bracket 22, and the extension bracket 23 may be respectively made of different materials. In another embodiment, a body of the gate seat includes a sheet metal part made by laser cutting and stamping. In still another embodiment, in addition to the sheet metal part, the body of the gate seat further includes a plurality of plastic components, which are respectively made by CNC milling and injection molding.

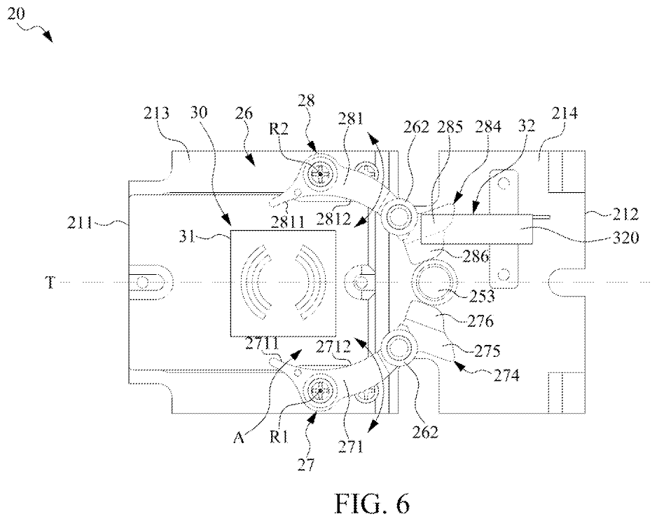

In an embodiment, the actuator 25 is disposed on a top surface of the second area 214 of the base 21. The actuator 25 may include a body 251 and an actuator holder 252. The actuator holder 252 is vertically disposed above the second area 214 of the base 21, and the body 251 includes a DC solenoid valve fixed to the actuator holder 252. A latch 253 (FIG. 6) is connected below the body 251, and the actuator 25 is operable to move the latch 253 between a locked position and a retracted position. In the locked position, the latch 253 extends out of the body 251, and in the retracted position, the latch 253 retracts into the body 251. In an embodiment, the latch 253 moves along a direction perpendicular to a plane where the base 21 is located, and the movement distance is 5 to 9 mm. Preferably, the movement distance of the latch 253 is 7 mm.

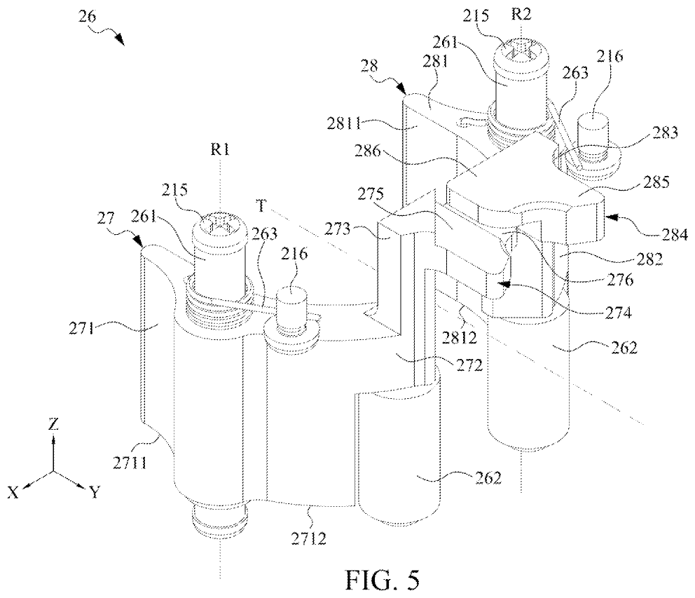

The gate plate assembly 26 is disposed on a bottom surface of the base 21 to control the passage of the umbrella. In an embodiment, as shown in FIG. 5, the gate plate assembly 26 includes a first gate plate 27 and a second gate plate 28. A sleeve 261 extends through the first gate plate 27 and the second gate plate 28, and a locking member 215 runs through the base 21 and extends into the sleeve 261, so that the first gate plate 27 and the second gate plate 28 are pivotable around a rotating shaft R1 and a rotating shaft R2 respectively. In addition, one end of each of two return springs 263 is connected to the first gate plate 27 or the second gate plate 28, and the other end of each of the two return springs 263 is connected to the base 21 to normally provide a restoring force, such that the first gate plate 27 and the second gate plate 28 can return to the closed position as shown in FIG. 5 after pivoting around the rotating shaft R1 and the rotating shaft R2. In an embodiment, as shown in FIG. 5, one end of each of the two return springs 263 is sleeved on an outer surface of the sleeve 261, and the other end of each of the two return springs 263 is fixed to a fixing member 216 on the bottom surface of the base 21. However, the instant disclosure is not limited thereto, and the two return springs 263 may be coupled to proper positions between the first gate plate 27 and the base 21 and between the second gate plate 28 and the base.

In an embodiment, the first gate plate 27 and the second gate plate 28 are structured to facilitate the entry of a handle of the umbrella therebetween. For example, as shown in FIG. 5, each of the first gate plate 27 and the second gate plate 28 includes a guiding structure 271, 281. Each of the guiding structures 271, 281 includes a straight section 2711, 2811 and a curved section 2712, 2812 (shown more clearly in FIG. 12). The straight section 2711, 2811 is located on a side of the guiding structure 271, 281 adjacent to the first end 211 (FIG. 4) of the base 21. When the first gate plate 27 and the second gate plate 28 are in a closed state shown in FIG. 5, the straight sections 2711, 2811 are disposed substantially parallel to the axis T. The curved section 2712, 2812 is located on a side of the guiding structure 271, 281 adjacent to the second end 212 of the base 21, and extends inward toward the axis T. In an embodiment, the straight section 2711 and the curved section 2712 are located on two sides of the rotating shaft R1, and the straight section 2811 and the curved section 2812 are located on two sides of the rotating shaft R2. The curvature of the curved section 2712 and the curved section 2812 may be the same as that of an outer surface of the handle of the umbrella to be matched therewith, to achieve the labor-saving effect.

In an embodiment, the gate plate assembly 26 further includes two rollers 262. The two rollers 262 are configured such that the handle of the umbrella can open and pass through the first gate plate 27 and the second gate plate 28 connected with the two rollers 262 when contacting the two rollers. In an embodiment, each of the first gate plate 27 and the second gate plate 28 further includes a horizontal extension structure 272, 282. The horizontal extension structure 272, 282 extends from a side edge of the guiding structure 271, 281 close to the locking structure 274, 284. The horizontal extension structure 272, 282 has the same curvature as the curved section 2712, 2812, but has a smaller height than the curved section 2712, 2812, thereby forming a notch below the horizontal extension structure 272, 282. The two rollers 262 are disposed in the notches, and can move along with the first gate plate 27 and the second gate plate 28. The two rollers 262 may be fixed in the notches, or disposed in the notches in a rotatable manner around a rotating shaft. Outer surfaces of the two rollers 262 may be covered with an elastic material (e.g., rubber), thereby reducing or avoiding the damage caused by the collision between the gate plate assembly 26 and the umbrella. In an embodiment, the horizontal extension structures 272, 282 and the two rollers 262 are omitted. Inner surfaces of the guiding structures 271, 281 may be lined with a soft elastic material, thereby reducing or avoiding the damage caused by the collision between the gate plate assembly 26 and the umbrella.

Each of the first gate plate 27 and the second gate plate 28 further includes a locking structure 274, 284. The locking structures 274, 284 are configured to engage with the latch 253 of the actuator 25. In an embodiment, when viewed in a horizontal direction, at least parts of the guiding structure 271, 281 and the locking structure 274, 284 are located in different horizontal planes. For example, in the embodiment shown in FIG. 5, each of the first gate plate 27 and the second gate plate 28 further includes a vertical extension structure 273, 283. The vertical extension structure 273, 283 vertically extends a height from an upper surface of the horizontal extension structure 272, 282. The locking structure 274, 284 is disposed on the vertical extension structure 273, 283. The height of the vertical extension structure 273, 283 may be the same as or slightly smaller than the height difference between the first area 213 and the second area 214 of the base 21.

In an embodiment, each of the locking structures 274, 284 includes a protruding portion 275, 285 and an overlapping portion 276, 286. The protruding portion 275, 285 extends a length in a direction away from the guiding structure and parallel to the axis T. The protruding portion 275, 285 has a width that tapers outward such that it can abut against the cylindrical latch 253 (FIG. 6). The overlapping portion 276, 286 is disposed on an inner side of the protruding portion 275, 285 close to the axis T. The overlapping portion 276 and the overlapping portion 286 are located at different heights, and when the first gate plate 27 and the second gate plate 28 are in the closed state shown in FIG. 5, the overlapping portion 276 and the overlapping portion 286 overlap each other.

FIG. 6 shows a schematic view of a gate plate assembly 26 between the closed position and the open position according to an embodiment of the instant disclosure. As shown in FIG. 6, a waiting zone A is defined between the guiding structures 271, 281 of the first gate plate 27 and the second gate plate 28. After the umbrella enters the gate plate assembly 26 and before the latch 253 of the actuator 25 moves to the retracted position, the handle of the umbrella is located in the waiting zone A to wait for the opening of the first gate plate 27 and the second gate plate 28.

The gate device 20 may further include a detection unit 30 to monitor states of the gate plate assembly 26 and the umbrella in real time. In an embodiment, the detection unit 30 of the gate device 20 includes an identification sensor 31 and a switch sensor 32. The identification sensor 31 is disposed on the first area 213 of the base 21 relative to the waiting zone A. The identification sensor 31 may include an RFID reader, and is disposed on the first area 213 of the base 21 through a plastic substrate. When the umbrella passes through the waiting zone A, the identification sensor 31 of the detection unit 30 may further identify an identity of the umbrella, generate a signal based on the detection result and transmit the signal back to the controller module. The switch sensor 32 is disposed on a bottom surface of the second area 214 of the base 21. The switch sensor 32 is disposed adjacent to the locking structure 284 and includes a body 320. The body 320 extends a length in a direction parallel to the axis T, and an end of the body 320 close to the gate plate assembly 26 includes a transversely extending channel 321 (shown more clearly in FIG. 4) through which the locking structure 284 passes. In an embodiment, the switch sensor 32 includes a sensor capable of detecting a passage of an object, for example, a photo-interrupter switch. As shown in FIG. 6, when the locking structure 284 passes through the switch sensor 32, the locking structure 284 shields signals of the photo-interrupter switch. Thus, the switch sensor 32 determines that an object has passed through, generates a signal based on the detection result, and transmits the signal back to the controller module. In another embodiment, the detection unit 30 is disposed adjacent to the locking structure 274, and configured to detect a passage of the locking structure 274.

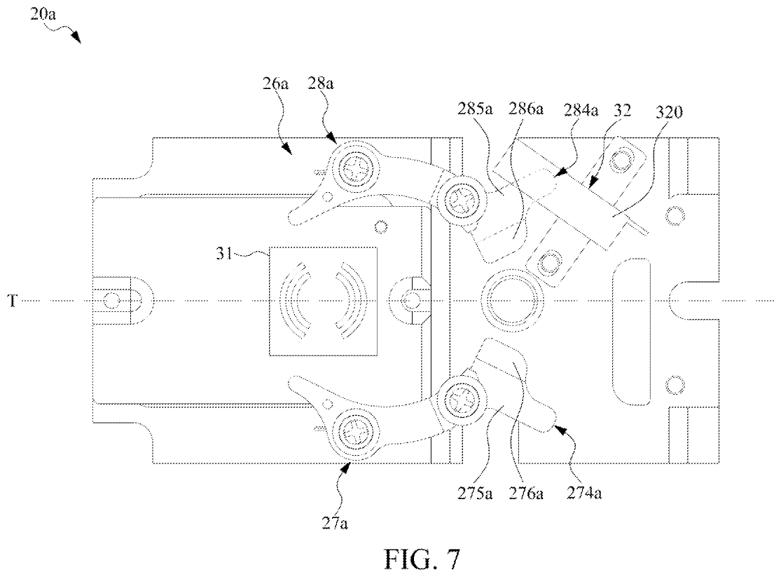

The form of the gate device is not only limited to the above embodiment, and the following is a further embodiment of the gate device. FIG. 7 shows a schematic bottom view of a gate device 20a according to another embodiment of the instant disclosure. Elements of the gate device 20a that are identical or similar to the gate device 20 will be given similar symbols and their features will not be described again. In an embodiment, the gate device 20a is different from the gate device 20 in that locking structures 274a, 284a on a first gate plate 27a and a second gate plate 28a of a gate plate assembly 26a have different shapes from the locking structures 274, 284 of the gate plate assembly 26. Specifically, each of the locking structures 274a, 284a includes a protruding portion 275a, 285a and an overlapping portion 276a, 286a. The body 320 of the switch sensor 32 is inclined outward with respect to the axis T. In this case, when an umbrella moves rightward along the axis T and initially interferes with the second gate plate 28a, the protruding portion 285a may shield the channel of the body 320 such that the switch sensor 32 generates a shielding signal. Then, the umbrella continues moving rightward along the axis T until a complete passage of the umbrella. At this time, the umbrella finishes its interference with the second gate plate 28a, the channel of the body 320 returns to its unshielded state, and the switch sensor 32 finishes the transmission of the shielding signal. This embodiment is different from the embodiment shown in FIG. 6 mainly in that: the controller module in this embodiment can independently determine whether the gate plates are being interfered with by detecting the shielding signal of the switch sensor 32, and there is no need to make a comprehensive determination based on the cumulative number of times the protruding portion 285a passes through the switch sensor 32.

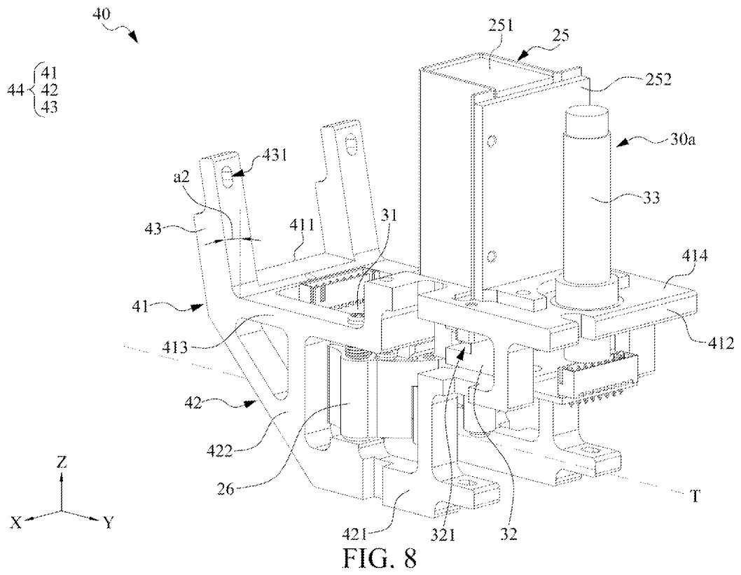

FIG. 8 shows a schematic view of the gate device 40 according to an embodiment of the instant disclosure. Similar to the structure of the gate device 20, the gate device 40 also includes a base 41, a bottom bracket 42, an extension bracket 43, an actuator 25, and a gate plate assembly 26. The base 41 extends along an axis T from a first end 411 to a second end 412 opposite to the first end 411. A first area 413 is adjacent to the first end 411, and a second area 414 is adjacent to the second end 412. The height of the second area 414 is greater than the height of the first area 413. The bottom bracket 42 is disposed on two opposite side edges below the base 41 to define a channel below the base 41 for the passage of the umbrella. In an embodiment, the bottom bracket 42 includes a connecting portion 421 and an inclined portion 422 inclined relative to the connecting portion. The extension bracket 43 is disposed adjacent to the second end 412 above the base 41, and a locking hole 431 is formed in the extension bracket 43.

The base 41, the bottom bracket 42, and the extension bracket 43 together form a gate seat 44 for carrying the actuator 25, the gate plate assembly 26, and the detection unit 30. In an exemplary embodiment, the gate seat 44 is formed by performing CNC (computer numerical control) milling on an aluminum extrusion as a blank. However, the instant disclosure is not limited thereto. The base 41, the bottom bracket 42, and the extension bracket 43 may be respectively made of different materials. In another embodiment, a body of the gate seat includes a sheet metal part made by laser cutting and stamping. In still another embodiment, in addition to the sheet metal part, the body of the gate seat further includes a plurality of plastic components, which are respectively made by CNC milling and injection molding.

In an embodiment, since the gate device 40 is disposed in the inclined section 1521 of the rail 15, in order to make the connecting portion 421 of the bottom bracket 42 to be disposed in parallel with the inclined section 1521 of the rail 15, the extension bracket 43 to be fixed to the side surface of the main body 13 forms an included angle a2 with respect to a direction perpendicular to the base 41 (direction Z). In an embodiment, the included angle a2 is the same as the included angle a1, so the first area 413 and the second area 414 of the gate device 40 are both disposed parallel to the inclined section 1521 of the rail 15.

In an embodiment, the actuator 25 is disposed on a top surface of the second area 414 of the base 41, and the gate plate assembly 26 is disposed on a bottom surface of the base 41 to control the passage of the umbrella. In addition, in addition to the identification sensor 31 and the switch sensor 32, a detection unit 30a of the gate device 40 further includes a position sensor 33. The arrangement of the actuator 25, the gate plate assembly 26, the identification sensor 31, and the switch sensor 32 in the gate device 40 is substantially the same as the arrangement of these elements in the gate device 20, and will not be repeated herein for the simplicity of description.

The position sensor 33 extends through the second area 414 of the base 41 adjacent to the second end 412 of the base 41, and is configured to detect the passage of an object, such as, but not limited to, an umbrella. In an exemplary embodiment, the position sensor 33 may include an infrared diffuse proximity switch. When the umbrella passes through the gate plate assembly 26 and moves toward the second end 412 of the base 41, the position sensor 33 detects the passage of the umbrella, generates a signal based on the detection result, and transmits the signal back to the controller module.

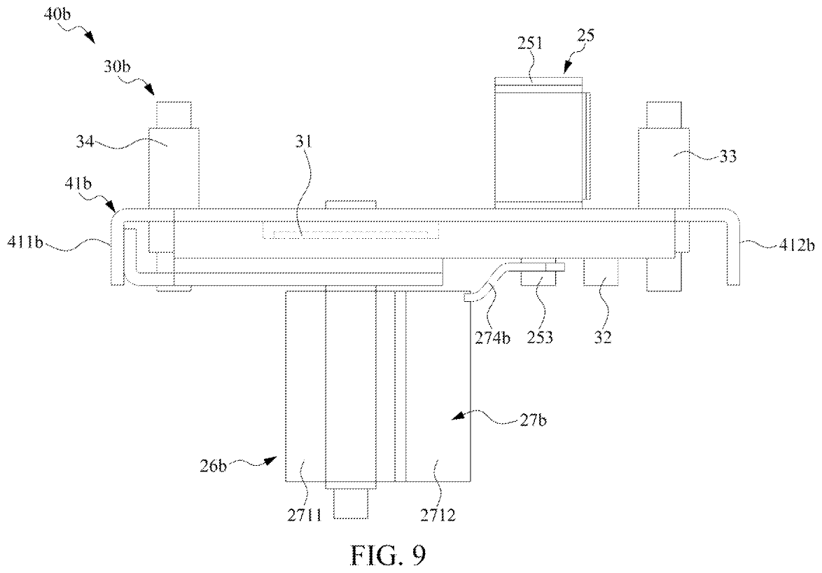

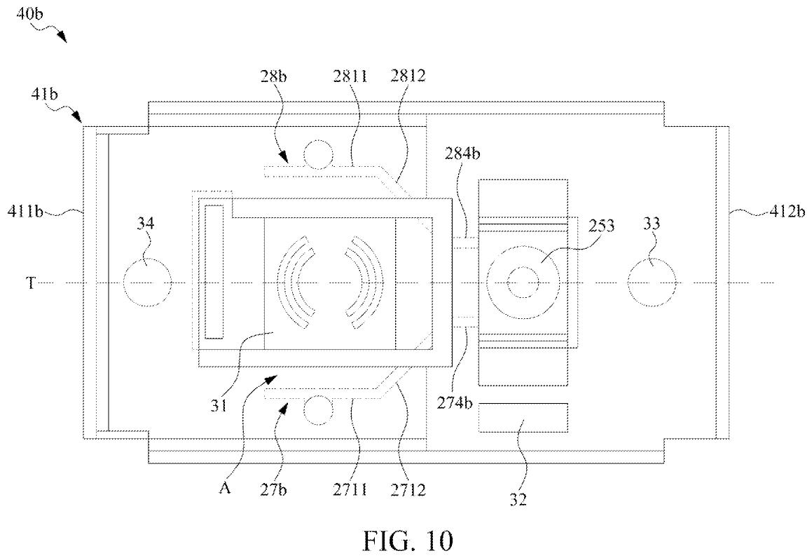

FIG. 9 shows a schematic side view of a gate device 40b disposed on the entrance end according to an embodiment of the instant disclosure. FIG. 10 shows a schematic bottom view of the gate device 40b of FIG. 9. The gate device 40b includes a base 41b, an actuator 25, a gate plate assembly 26b, and a detection unit 30b.

The gate plate assembly 26b is disposed below the base 41b and includes a first gate plate 27b and a second gate plate 28b. The first gate plate 27b and the second gate plate 28b each include a straight section 2711, 2811, a curved section 2712, 2812, and a locking structure 274b, 284b. The straight section 2711, 2811 is located on a side of the first gate plate 27b and the second gate plate 28b adjacent to a first end 411b of the base 41b. When the first gate plate 27b and the second gate plate 28b is in a closed state shown in FIG. 10, the straight sections 2711, 2811 are substantially parallel to the axis T, and a waiting zone A is defined between the straight sections 2711, 2811. The curved section 2712, 2812 is inclined with respect to the axis Y, and extends to between the straight section 2711, 2811 and the locking structure 274b, 284b. The locking structures 274b, 284b are configured to engage with the latch 253.

In addition to the identification sensor 31, the switch sensor 32 and the position sensor 33, the detection unit 30b further includes a position sensor 34. Similar to the position sensor 33, the position sensor 34 may include an infrared diffuse proximity switch. For ease of understanding, the position sensor 33 is referred to as a rear-end position sensor and the position sensor 34 is referred to as a front-end position sensor in the following description. The rear-end position sensor 33 and the front-end position sensor 34 are disposed on the axis T, and respectively located on two sides of the waiting zone A, to detect the passage of the umbrella when the umbrella is moved in and out of the waiting zone A, generate a signal based on the detection result and transmit the signal back to the controller module.

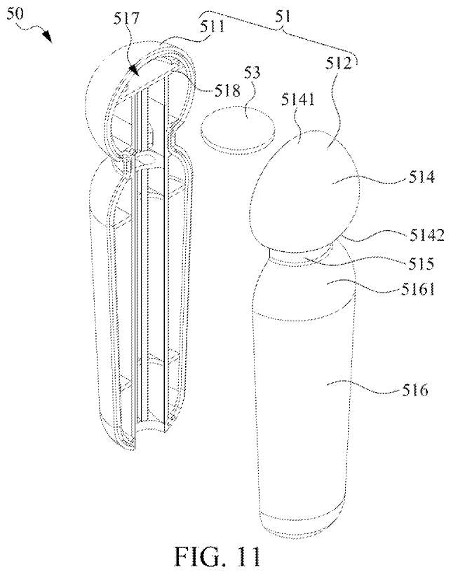

FIG. 11 shows a structural exploded view of a handle 51 of the umbrella 50 according to an embodiment of the instant disclosure. In an embodiment, the handle 51 is a columnar structure formed by a first half 511 and a second half 512, and includes a head 514 and a grip portion 516. The head 514 is located on a free end of the handle 51, and the grip portion 516 is coupled to a lower end of the head 514 and connected with a body 52 of the umbrella 50 (FIG. 1). An annular groove 515 is formed between the head 514 and the grip portion 516. After the handle 51 enters the rail 15 (FIG. 3), the two plates 152 (FIG. 3) of the rail 15 extend into the groove 515, so that the handle 51 slides on the rail 15 by means of the groove 515. In an embodiment, in order to make the handle 51 enter the rail 15 more smoothly, a lower end 5142 of the head 514 close to the groove 515 and an upper end 5161 of the grip portion 516 close to the groove are both smooth curved surfaces. In addition, an accommodating space 517 is formed inside the head 514 close to the upper end 5141 thereof, to receive an identification chip 53 that records identity data corresponding to the umbrella 50. Therefore, when the handle 51 slides through the waiting zone of the gate plate assembly according to any of the embodiments above, the identification sensor 31 identifies the identification chip 53 to determine the identity of the umbrella 50.

According to an embodiment of the instant disclosure, the flow of a user moving out (renting) an umbrella is described as follows:

First, the user who has registered as a member in advance can search for the position of the umbrella rental station 10 as shown in FIG. 1 through an application (APP) of a mobile phone, and after arriving at the umbrella rental station 10, scan a barcode 16 (for example, QR Code) on the main body 13 through the APP in the mobile phone to start a service program. In the service program, the remote servo system 60 first diagnoses the current state of the umbrella rental station 10, including checking whether all elements are operating normally and whether there are still umbrellas available for rental in the umbrella rental station 10. If the umbrella rental station 10 is found to be abnormal, e.g., there are no umbrellas or the umbrella rental station is full, etc., the user will be prompted that the umbrella rental station 10 is currently unavailable, and will be directed to another umbrella rental station 10 via the APP in the mobile phone. When the umbrella rental station 10 can operate normally, after the user completes the payment action through the APP in the mobile phone, the remote servo system 60 wakes up the umbrella rental station 10 from the dormant state.

As shown in FIG. 12, in some embodiments, the handle 51 of the umbrella to be taken out may not enter the waiting zone A of the gate device 20 along the rail 15. Since the identification sensor 31 does not detect the presence of the handle 51 in the waiting zone A, when the user wants to rent an umbrella, the umbrella rental station 10 first prompts the user to manually move the handle 51 of a single umbrella into the waiting zone A of the gate device 20 on the right side of the main body 13 by means of the speakers 18 (FIG. 3) or visual information on the APP interface.

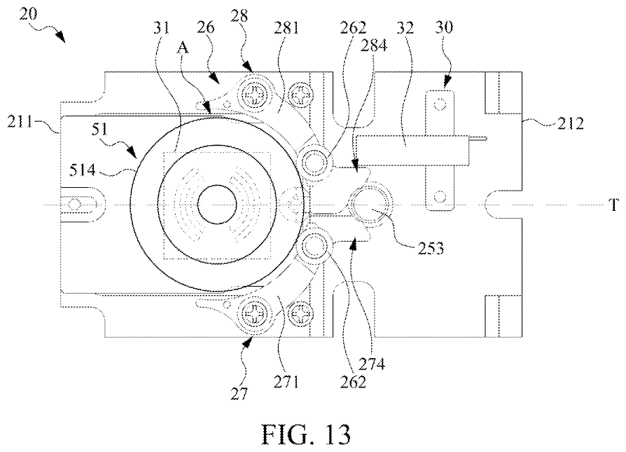

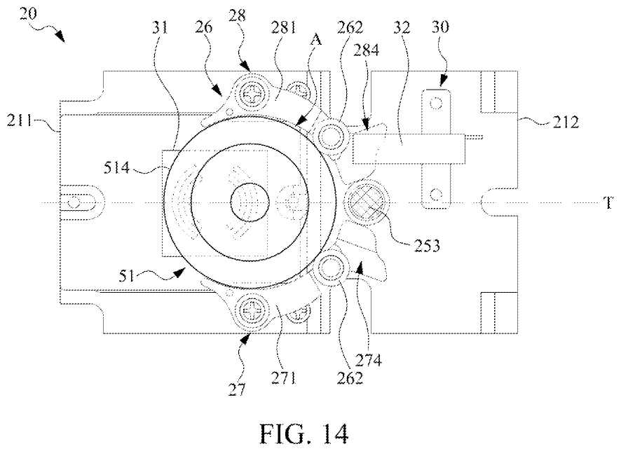

As shown in FIG. 13, when the identification sensor 31 detects the presence of the umbrella 50 in the waiting zone A, the umbrella rental station 10 transmits the identity of the umbrella 50 back to the remote servo system 60, which then matches the identity of the user. After the completion of the matching, the remote servo system 60 transmits a signal to control the actuator 25 to move the latch 253 to the retracted position shown in FIG. 14, thereby allowing the first gate plate 27 and the second gate plate 28 to be opened.

As shown in FIG. 12, when the handle 51 of the umbrella is moved into the waiting zone A of the gate device 20, since the straight sections 2711, 2811 of the guiding structures 271, 281 are disposed parallel to the axis T, the handle 51 of the umbrella can be smoothly guided into the waiting zone A through the straight sections 2711, 2811. Additionally, as shown in FIG. 13, since the curved sections 2712, 2812 of the guiding structures 271, 281 have the same curvature as the outer surface of the handle 51 of the umbrella, the outer surface of the handle 51 can abut against the rollers 262 disposed on one side of the curved sections 2712, 2812. Thus, as shown in FIG. 14, when the user further moves the handle 51 of the umbrella, the handle 51 of the umbrella can pivot the first gate plate 27 and the second gate plate 28 outward by abutting against the rollers 262, and then the umbrella can be taken out smoothly.

In an embodiment, in order to ensure the user to only take out one single umbrella, the instant disclosure provides the following debugging mechanism:

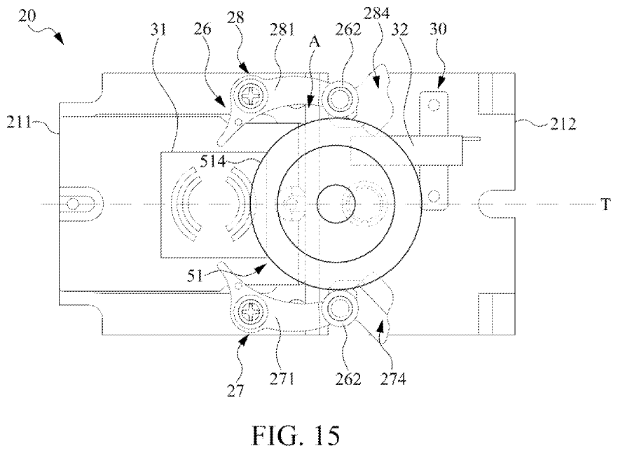

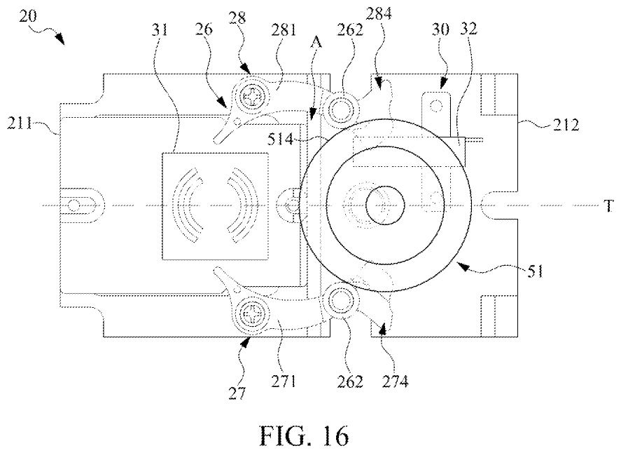

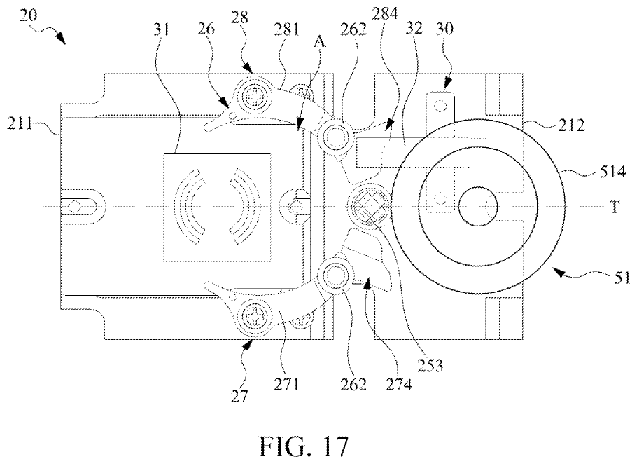

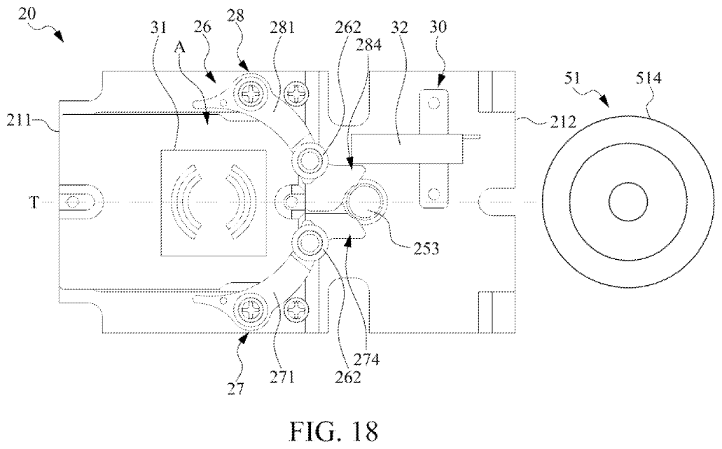

As shown in FIG. 14, when the user pushes the handle 51 of the umbrella to open the first gate plate 27 and the second gate plate 28, the locking structure 284 of the second gate plate 28 passes through the switch sensor 32 for the first time. Additionally, as shown in FIG. 15, when the handle 51 of the umbrella completely moves the first gate plate 27 and the second gate plate 28 to the open position, the locking structure 284 of the second gate plate 28 is moved out from the outer side of the switch sensor 32. Next, as shown in FIG. 16 and FIG. 17, as the handle 51 of the umbrella continuously moves toward the exit end, the locking structure 284 of the second gate plate 28 passes through the switch sensor 32 for the second time. Finally, as shown in FIG. 18, when the handle 51 of the umbrella is completely moved out of the gate plate assembly 26, the locking structure 284 of the second gate plate 28 is also moved out from the inner side of the switch sensor 32. The controller module detects the two shielding signals transmitted by the switch sensor 32, and thus determines that the user has smoothly taken out of the umbrella and that the gate plate assembly 26 has been opened and closed normally. In some embodiments, the actuator 25 may move the latch 253 to the locked position within a predetermined time (e.g., less than 1 s) after the locking structure 284 of the second gate plate 28 passes through the switch sensor 32 for the second time. Alternatively, the actuator 25 may move the latch 253 to the locked position within a predetermined time (e.g., less than 10 s) after the latch 253 retracts. When the latch 253 moves to the locked position, the latch 253 engages with the locking structures 274, 284 again, and restricts the opening of the first gate plate 27 and the second gate plate 28.

However, in some abnormal situations, the user may attempt to move out a second umbrella from the gate device 20 before the latch 253 locks the first gate plate 27 and the second gate plate 28. In this case, since the switch sensor 32 will detect the passage of the locking structure 284 of the second gate plate 28 again and transmit an abnormality signal to the controller module, the controller module may respond to this abnormality signal, notify the remote service background to make a record, and sound an alarm through the speakers to prevent the umbrella from being stolen.

The flow of moving (returning) the umbrella into the umbrella rental station 10 is substantially the same as the flow of moving (renting) the umbrella out of the umbrella rental station 10. In the embodiment where the gate device 40 is provided with the rear-end position sensor 33 and the front-end position sensor 34, the controller module may monitor the detection signals of the rear-end position sensor 33 and the front-end position sensor 34 to further optimize the returning and renting flows. For example, the detection signal of the rear-end position sensor 33 may be used for determining whether the umbrella has entered the storage zone of the rail in the returning procedure, or determining whether the user has smoothly moved out the umbrella or whether a second umbrella is moved out in the renting procedure. The detection signal of the front-end position sensor 34 may be used for enabling the controller module from the dormant state in the returning procedure, or determining whether an umbrella enters the waiting zone in the renting procedure.

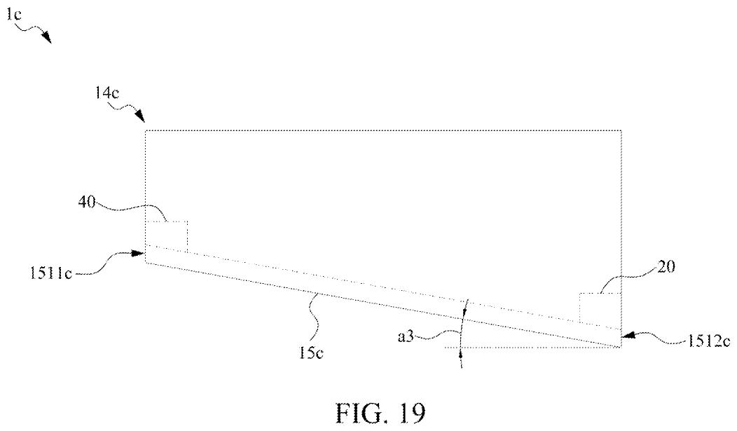

FIG. 19 shows a schematic front view of an umbrella sharing system 1c according to another embodiment of the instant disclosure. Elements of the umbrella sharing system 1c that are identical or similar to the umbrella sharing system 1 will be given similar symbols and their features will not be described again. In an embodiment, the umbrella sharing system 1c is different from the umbrella sharing system 1 in that the rail 15 is replaced with a rail 15c. The rail 15c is disposed in an elongated opening below a housing 14c, and defines an elongated slot which allows umbrellas to slide through and has an entrance end 1511c and an exit end 1512c. The rail 15c includes an inclined section which extends from the entrance end 1511c to the exit end 1512c of the elongated slot (i.e., the elongated slot that allows the umbrellas to slide through does not have a horizontal section parallel to the horizontal direction). The gate devices 20, 40 are respectively disposed on the rail 15c relative to the exit end 1512c and the entrance end 1511c of the elongated slot. The inclined section of the rail 15c is inclined at an included angle a3 with respect to the horizontal direction. In an example, the included angle a3 is from 7 degrees to 20 degrees. Preferably, the included angle a3 is about 12 degrees. The inclined section of the rail 15c extends from the entrance end 1511c to the exit end 1512c of the elongated slot, so the umbrella can slide smoothly by gravity to the gate device 20 located on the exit end 1512 after passing through the gate device 40 of the entrance end 1511c, thereby simplifying the operating procedure of the user.

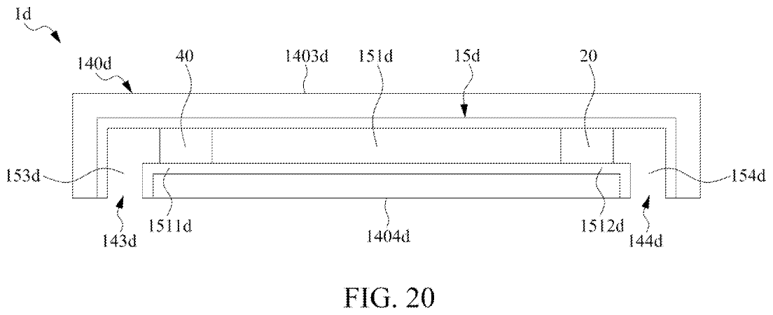

FIG. 20 shows a schematic sectional view of an umbrella sharing system 1d when viewed at an inclined angle along a rail 15d according to another embodiment of the instant disclosure. Elements of the umbrella sharing system 1d that are identical or similar to the umbrella sharing system 1 will be given similar symbols and their features will not be described again. In an embodiment, the umbrella sharing system 1d is different from the umbrella sharing system 1 in that the housing 14 is replaced with a housing 14d and the rail 15 is replaced with a rail 15d. A body 140d of the housing 14d includes two side covers 1403d and 1404d disposed oppositely. The side cover 1404d faces the side operated by the user.

The rail 15d is disposed in an elongated opening below the housing 14d, and defines a first short-side slot 153d, an elongated slot 151d, and a second short-side slot 154d which allow the umbrellas to slide through and are sequentially connected. The structure of the elongated slot 151d of the rail 15d may be the same as that of the rail 15 shown in FIG. 3, or the same as that of the rail 15c shown in FIG. 19. The first short-side slot 153d is coupled to an entrance end 1511d of the elongated slot 151d and communicates with an entrance channel 143d on the side cover 1404d. The second short-side slot 154d is coupled to an exit end 1512d of the elongated slot 151d and communicates with an exit channel 144d on the side cover 1404d. The first short-side slot 153d and the second short-side slot 154d respectively form an included angle of greater than 0 degrees with the elongated slot 151d. In an exemplary embodiment, the included angle may be substantially 90 degrees. In another exemplary embodiment, the included angle is greater than 90 degrees, for example, 135 degrees.

When the user wants to return the umbrella, the user may insert the handle of the umbrella (for example, the umbrella 50) into the first short-side slot 153d of the rail 15d via the entrance channel 143d, and push the handle inward such that the handle first passes through the first short-side slot 153d and then enters the gate device 40 disposed relative to the entrance end 1511d. The umbrella is stored in the elongated slot 151d after passing through the gate device 40. When the user wants to move the umbrella out, the user first passes the handle of the umbrella through the gate device 20 disposed relative to the exit end 1512d, and then moves the umbrella into the second short-side slot 154d, such that the handle first passes through the second short-side slot 154d and then leaves the rail 15d and the exit channel 144d. Since the entrance channel 143d and the exit channel 144d are both formed on the side covers 1404d of the housing 14d facing the user, the user can return or move out the umbrella more conveniently, and the possibility of the machine being damaged due to misoperation is reduced.

The embodiments of the instant disclosure provide a gate device and an umbrella sharing system which utilizes the gate device. By disposing the gate devices, the umbrella sharing system can manage the umbrella returning and renting flows in real time and can detect the occurrence of abnormalities. In addition, by means of the hardware design of the umbrella sharing system and the gate device, the umbrella can smoothly and stably slide in the rail and pass through the gate plates, thereby greatly improving the user experience.

The embodiments described above are only for explaining the technical idea and characteristics of the instant disclosure with the purpose to enable those skilled in the art to understand the contents of the instant disclosure and implement them accordingly, and are not intended to limit the scope of the instant disclosure. Any equivalent change or modification made in accordance with the spirit of the instant disclosure shall fall within the scope of the instant disclosure.

What is claimed is:

1. A gate device, comprising:
a base, extending from a first end to a second end along an axis, and comprising a first area and a second area respectively adjacent to the first end and the second end;
an actuator, disposed on a top surface of the second area of the base and comprising a latch extending downward through the base, the actuator being operable to move the latch between a locked position and a retracted position;
a first gate plate and a second gate plate, disposed on a bottom surface of the first area of the base, when the latch is in the locked position, the first gate plate and the second gate plate engaging with the latch such that pivoting the first gate plate and the second gate plate is limited to a closed position, and when the latch is in the retracted position, the first gate plate and the second gate plate being separated from the latch such that the first gate plate and the second gate plate are pivotable from the closed position to an open position; and
an identification sensor, disposed on the first area of the base relative to a waiting zone defined between the first gate plate and the second gate plate and configured to identify an identity of an umbrella which passes through the gate device.

2. The gate device according to claim 1, wherein each of the first gate plate and the second gate plate comprises:
a guiding structure, the waiting zone being defined between the guiding structures of the first gate plate and the second gate plate; and
a locking structure, connected with the guiding structure and extending toward the second end of the base, when the latch is in the locked position, the locking structures of the first gate plate and the second gate plate engaging with the latch, and when the latch is in the retracted position, the latch being separated from the locking structure.

3. The gate device according to claim 2, wherein each of the locking structures of the first gate plate and the second gate plate comprises:
a protruding portion, extending a length in a direction away from the guiding structure; and
an overlapping portion, connected with an inner side edge of the protruding portion, when the latch is in the locked position and the first gate plate and the second gate plate are in the closed position, the overlapping portions of the first gate plate and the second gate plate overlapping each other and engaging with the latch.

4. The gate device according to claim 2, wherein the guiding structure comprises:
a straight section, located on a side of the guiding structure adjacent to the first end of the base, when the first gate plate or the second gate plate is in the closed position, the straight section being substantially parallel to the axis; and
a curved section, located on a side of the guiding structure adjacent to the second end of the base and extending inward toward the axis.

5. The gate device according to claim 2, wherein each of the first gate plate and the second gate plate further comprises a horizontal extension structure, the horizontal extension structure extending from a side edge of the guiding structure close to the locking structure and having a smaller height than the guiding structure,
and the gate device further comprises two rollers, the two rollers being respectively disposed below the two horizontal extension structures and moving together with the first gate plate and the second gate plate, and the two rollers comprising an elastic material.

6. The gate device according to claim 1, further comprising a switch sensor, the switch sensor being disposed on a bottom surface of the second area of the base,
wherein when the first gate plate and the second gate plate move between the closed position and the open position, the switch sensor detects a passage of a part of one of the first gate plate and the second gate plate to determine whether an abnormality occurs.

7. The gate device according to claim 1, further comprising a position sensor, wherein the position sensor is disposed on the axis, located on any side of the waiting zone and configured to detect a passage of the umbrella.

8. The gate device according to claim 1, further comprising two return springs, wherein one end of each of the two return springs is connected to the first gate plate or the second gate plate, and the other end of each of the two return springs is connected to the base, the two return springs normally providing a restoring force to return the first gate plate and the second gate plate to the closed position.

9. An umbrella sharing system, comprising:
a housing, having an elongated opening at a lower end thereof;
a rail, comprising an elongated slot extending along the elongated opening;
two gate devices according to claim 1, respectively disposed on an entrance end and an exit end of the elongated slot; and
an umbrella, comprising:
a handle, defining a groove, the handle sliding on the rail through the groove, the two gate devices being configured such that the handle enters the gate device via the first end of the base and leaves the gate device via the second end of the base after passing through the waiting zone between the first gate plate and the second gate plate; and
an identification chip, disposed in a head of the handle such that when the handle slides through the waiting zone, the identification sensor identifies the identification chip to determine an identity of the umbrella.

10. The umbrella sharing system according to claim 9, wherein the rail comprises:
an inclined section, extending from the entrance end of the elongated slot to the exit end and inclined at an included angle with respect to a horizontal direction, the two gate devices being both disposed in the inclined section.

11. The umbrella sharing system according to claim 9, wherein the rail comprises:
an inclined section, extending a predetermined length from the entrance end of the elongated slot and inclined at an included angle with respect to a horizontal direction; and
a horizontal section, connected with one end of the inclined section and extending to the exit end of the elongated slot along the horizontal direction, the two gate devices being respectively disposed in the inclined section and the horizontal section.

12. The umbrella sharing system according to claim 10, wherein the gate device located on the entrance end of the elongated slot further comprises an extension bracket, the extension bracket protruding upward from the first end of the base, and the extension bracket being inclined at the included angle with respect to a direction perpendicular to the base such that the base is disposed substantially parallel to the inclined section in an assembled state.

13. The umbrella sharing system according to claim 10, wherein the included angle is about 7 degrees to about 20 degrees.

14. The umbrella sharing system according to claim 9, wherein the rail further comprises:
a first short-side slot, coupled to the entrance end of the elongated slot; and
a second short-side slot, coupled to the exit end of the elongated slot, the first short-side slot and the second short-side slot respectively forming an included angle of greater than 0 degrees with the elongated slot,
wherein the handle passes through the first short-side slot and then enters the gate device disposed relative to the entrance end, and the handle passes through the second short-side slot and then leaves the rail after being moved out of the gate device disposed relative to the exit end.

15. An umbrella sharing system, comprising:
a rail, defining an elongated slot that allows an umbrella to slide through, at least one section of the elongated slot being inclined at an included angle with respect to a horizontal direction, and the included angle being about 7 degrees to about 20 degrees;
two gate devices, respectively disposed on the rail relative to an entrance end and an exit end of the elongated slot; and
an umbrella, configured to be slidable on the rail, one of the two gate devices disposed relative to the entrance end being configured to control the umbrella to be moved into the elongated slot, and the other of the two gate devices disposed relative to the exit end being configured to control the umbrella to be moved out of the elongated slot.

16. The umbrella sharing system according to claim 15, wherein the rail comprises:
an inclined section, extending from the entrance end of the elongated slot to the exit end and inclined at the included angle with respect to the horizontal direction, the two gate devices being both disposed in the inclined section.

17. The umbrella sharing system according to claim 15, wherein the rail comprises:
an inclined section, extending a predetermined length from the entrance end of the elongated slot and inclined at the included angle with respect to the horizontal direction; and
a horizontal section, connected with one end of the inclined section and extending to the exit end of the elongated slot along the horizontal direction, the two gate devices being respectively disposed in the inclined section and the horizontal section.

18. The umbrella sharing system according to claim 15, wherein at least one of the two gate devices comprises:
a base, extending from a first end to a second end along an axis, and comprising a first area and a second area respectively adjacent to the first end and the second end;
an actuator, disposed on a top surface of the second area of the base and comprising a latch extending downward through the base, the actuator being operable to move the latch between a locked position and a retracted position; and
a first gate plate and a second gate plate, disposed on a bottom surface of the first area of the base, when the latch is in the locked position, the first gate plate and the second gate plate engaging with the latch such that pivoting the first gate plate and the second gate plate is limited to a closed position, and when the latch is in the retracted position, the first gate plate and the second gate plate being separated from the latch such that the first gate plate and the second gate plate are pivotable from the closed position to an open position.

19. The umbrella sharing system according to claim 15, wherein at least one of the two gate devices comprises:
an identification sensor, configured to identify an identity of the umbrella which passes through the at least one of the two gate devices.

20. The umbrella sharing system according to claim 15, wherein the rail further comprises:
a first short-side slot, coupled to the entrance end of the elongated slot; and
a second short-side slot, coupled to the exit end of the elongated slot, the first short-side slot and the second short-side slot respectively forming an included angle of greater than 0 degrees with the elongated slot,
wherein a handle passes through the first short-side slot and then enters the gate device disposed relative to the entrance end, and the handle passes through the second short-side slot and then leaves the rail after being moved out of the gate device disposed relative to the exit end.
